(19) United States
(12) Patent Application Publication
(10) Pub. No.: US 2022/0303125 A1
(43) Pub. Date: Sep. 22, 2022

(54) INFORMATION PROCESSING APPARATUS, NODE, DATA RECORDING METHOD, AND COMPUTER READABLE MEDIUM

(71) Applicant: NEC Corporation, Minato-ku, Tokyo (JP)

(72) Inventors: Batnyam ENKHTAIVAN, Tokyo (JP); Akiko INOUE, Tokyo (JP)

(73) Assignee: NEC Corporation, Minato-ku, Tokyo (JP)

(21) Appl. No.: 17/635,528

(22) PCT Filed: Aug. 26, 2019
(86) PCT No.: PCT/JP2019/033291

§ 371 Date: Feb. 15, 2022

(51) Int. Cl. H04L 9/08; H04L 9/32; H04L 9/00

(52) U.S. Cl. CPC H04L 9/0825; H04L 9/0897; H04L 9/3247; H04L 9/50

(57) ABSTRACT

An information processing apparatus (2) includes a storage unit (21) in a secure area (20), the storage unit being configured to store a first common key (211) and a first private key (212) assigned to a measuring apparatus (1), an acquiring unit (223) configured to acquire, from the measuring apparatus (1), communication data including measurement data measured by the measuring apparatus (1) and an authentication code generated for the measurement data using the first common key (211), an authentication unit (221) configured to authenticate, in the secure area (20). the authentication code in the communication data using the first common key (211), a signature generation unit (222) that generates, in the secure area (20), when the authentication code is authenticated, a first digital signature for the measurement data in the communication data using the first private key (212), and a transmitting unit (224) configured to transmit, to a predetermined node (3), transaction data including the measurement data and the first digital signature to cause the predetermined node (3) to record the transaction data in a blockchain (4).

### TECHNICAL FIELD

The present disclosure relates to an information processing apparatus, a node, a data recording method, and a computer readable medium.

### BACKGROUND ART

Internet of things (IoT) devices have become widespread in recent years, and the demand to collect and utilize sensor data measured by IoT devices is increasing. There is also a need to record collected sensor data in a blockchain to maintain the reliability of data.

Here, Patent Literature 1 discloses a technique relating to data transmission from an IoT service to an IoT device via an IoT hub. Patent Literature 2 discloses a technique for improving security in a distributed file sharing system.

### CITATION LIST

### Patent Literature

Patent Literature 1: Published Japanese Translation of PCT International Publication for Patent Application, No. 2019-511141
Patent Literature 2: Japanese Unexamined Patent Application Publication No. 2018-081464

### SUMMARY OF INVENTION

### Technical Problem

There is a problem in that it is difficult to record in a blockchain data measured by a measuring apparatus such as an IoT device while maintaining reliability. In general, in order to write data into a blockchain, it is necessary to hold a public key and a private key and generate a digital signature for the data to be written. However, the calculation resources of the measuring apparatus is often limited and it is difficult for the measuring apparatus to write measurement data directly into a blockchain. This makes it difficult to record measurement data in a blockchain while maintaining reliability.

The present disclosure has been made to solve such a problem and it is an object of the present disclosure to provide an information processing apparatus, a node, a data recording method, and a computer readable medium for recording measurement data of a measuring apparatus in a blockchain while maintaining reliability.

### Solution to Problem

An information processing apparatus according to a first aspect of the present disclosure includes a storage unit in a secure area, the storage unit being configured to store a first common key for both the information processing apparatus and a predetermined measuring apparatus and at least a first private key out of a pair of the first private key and a first public key assigned to the measuring apparatus, an acquiring unit configured to acquire, from the measuring apparatus, communication data including measurement data measured by the measuring apparatus and an authentication code generated for the measurement data using the first common key, an authentication unit configured to authenticate, in the secure area, the authentication code in the communication data using the first common key, a signature generation unit configured to generate, in the secure area, when the authentication code is authenticated, a first digital signature for the measurement data in the communication data using the first private key, and a transmitting unit configured to transmit, to a predetermined node, transaction data including the measurement data and the first digital signature to cause the node to record the transaction data in a blockchain.

A node according to a second aspect of the present disclosure includes a storage unit configured to store a first public key out of a pair of a first private key and the first public key assigned to a predetermined measuring apparatus, a receiving unit configured to receive, from an information processing apparatus, transaction data including measurement data measured by the measuring apparatus and a first digital signature, the first digital signature being generated from the measurement data using the first private key in a secure area of the information processing apparatus when communication data is authenticated in the secure area using a first common key, the communication data including the measurement data and an authentication code generated for the measurement data using the first common key, a verification unit configured to verify the first digital signature included in the transaction data using the first public key, and a signature generation unit configured to generate, for the transaction data, a node signature being a digital signature for recording the transaction data in a blockchain, when the first digital signature is verified.

A data recording method according to a third aspect of the present disclosure includes, by a computer, acquiring, from a predetermined measuring apparatus, communication data including measurement data measured by the measuring apparatus and an authentication code generated for the measurement data using a first common key for both the computer and the measuring apparatus, authenticating, in a secure area, the authentication code in the communication data using the first common key, generating, in the secure area, when the authentication code is authenticated, a first digital signature for the measurement data in the communication data using a first private key out of a pair of the first private key and a first public key assigned to the measuring apparatus, and transmitting transaction data including the measurement data and the first digital signature to a predetermined node to cause the node to record the transaction data in a blockchain.

A computer readable medium according to a fourth aspect of the present disclosure is a non-transitory computer readable medium storing a program causing a computer to execute authentication processing of authenticating, in a secure area, an authentication code in communication data using a first common key for both the computer and a predetermined measuring apparatus, the communication data including measurement data measured by the measuring apparatus and the authentication code generated for the measurement data using the first common key, signature generation processing of generating, in the secure area, when the authentication code is authenticated, a first digital signature for the measurement data in the communication data using a first private key out of a pair of the first private key and a first public key assigned to the measuring apparatus, and output processing of outputting transaction data including the measurement data and the first digital signature to an area outside the secure area to transmit the transaction data to a predetermined node to cause the node to record the transaction data in a blockchain.

A data recording method according to a fifth aspect of the present disclosure includes, by a computer, receiving, from an information processing apparatus, transaction data including measurement data measured by a predetermined measuring apparatus and a first digital signature, the first digital signature being generated, in a secure area of the information processing apparatus, from the measurement data using a first private key out of a pair of the first private key and a first public key assigned to the measuring apparatus when communication data is authenticated in the secure area using a first common key, the communication data including the measurement data and an authentication code generated for the measurement data using the first common key, verifying the first digital signature included in the transaction data using the first public key, and generating, for the transaction data, a node signature being a digital signature for recording the transaction data in a blockchain, when the first digital signature is verified.

A computer readable medium according to a sixth aspect of the present disclosure is a non-transitory computer readable medium storing a program causing a computer to execute processing of receiving, from an information processing apparatus, transaction data including measurement data measured by a predetermined measuring apparatus and a first digital signature, the first digital signature being generated, in a secure area of the information processing apparatus, from the measurement data using a first private key out of a pair of the first private key and a first public key assigned to the measuring apparatus when communication data is authenticated in the secure area using a first common key, the communication data including the measurement data and an authentication code generated for the measurement data using the first common key, processing of verifying the first digital signature included in the transaction data using the first public key, and processing of generating, for the transaction data, a second digital signature for recording the transaction data in a blockchain, when the first digital signature is verified.

### Advantageous Effects of Invention

According to the above aspects, it is possible to provide an information processing apparatus, a node, a data recording method, and a computer readable medium for recording measurement data obtained by a measuring apparatus in a blockchain while maintaining reliability.

### BRIEF DESCRIPTION OF THE DRAWINGS

FIG. 1 is a block diagram illustrating an overall configuration of a data recording system according to a first example embodiment.

FIG. 2 is a sequence diagram illustrating a series of steps of a data recording process according to the first example embodiment.

FIG. 3 is a block diagram illustrating an overall configuration of a data recording system according to a second example embodiment.

FIG. 4 is a block diagram illustrating a hardware configuration of trusted hardware according to the second example embodiment.

FIG. 5 is a sequence diagram illustrating a series of steps of a data recording process according to the second example embodiment.

FIG. 6 is a block diagram illustrating an overall configuration of a data recording system according to a third example embodiment.

FIG. 7 is a diagram illustrating an example of a key management table of a THW according to the third example embodiment.

FIG. 8 is a diagram illustrating an example of a key management table of a data management server according to the third example embodiment.

FIG. 9 is a block diagram illustrating an overall configuration of a data recording system according to a fourth example embodiment.

FIG. 10 is a flowchart illustrating a series of steps of a key update process according to the fourth example embodiment.

FIG. 11 is a block diagram illustrating a configuration of trusted hardware according to a fifth example embodiment.

FIG. 12 is a flowchart illustrating a series of steps of a data recording process according to the fifth example embodiment.

FIG. 13 is a block diagram illustrating a configuration of trusted hardware according to a sixth example embodiment.

FIG. 14 is a flowchart illustrating a series of steps of a data recording process according to the sixth example embodiment.

### DESCRIPTION OF EMBODIMENTS

Hereinafter, example embodiments of the present disclosure will be described in detail with reference to the drawings. In each drawing, the same or corresponding elements are denoted by the same reference signs and duplicate explanations are omitted as necessary for the sake of clarity of explanation.

### First Example Embodiment

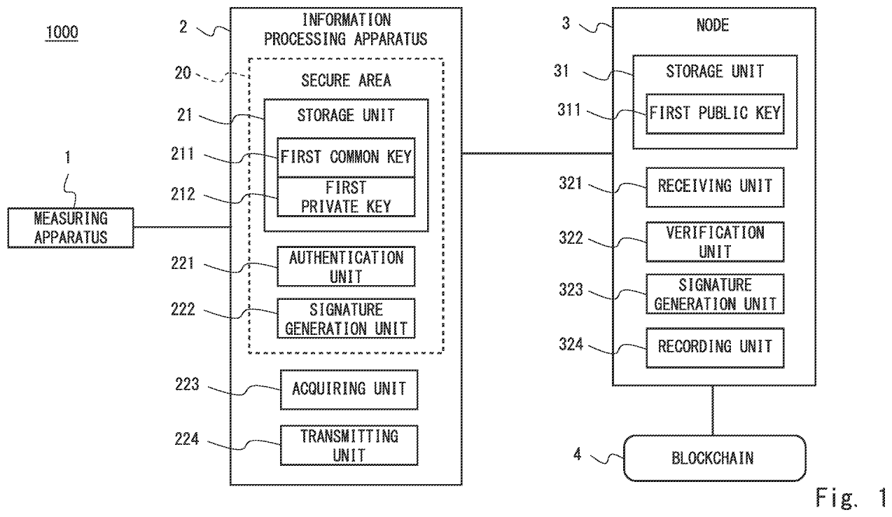

FIG. 1 is a block diagram illustrating an overall configuration of a data recording system 1000 according to a first example embodiment. The data recording system 1000 includes a measuring apparatus 1, an information processing apparatus 2, a node 3, and a blockchain 4. The measuring apparatus 1 holds a first common key for both the measuring apparatus 1 and the information processing apparatus 2 in advance. The measuring apparatus 1 measures a predetermined measurement target to generate measurement data and generates, for the measurement data, an authentication code using the first common key. Examples of the authentication code include, but are not limited to, an advanced encryption standard (AES)-cipher-based message authentication code (MAC) (AES-CMA), an AES-one-key cipher block chaining (CBC) MAC (AES-OMAC), and a hash-based message authentication code (HMAC). Then, the measuring apparatus 1 includes the authentication code and the measurement data in communication data. For example, the measuring apparatus 1 transmits the communication data to the information processing apparatus 2. The measuring apparatus 1 is, for example but not limited to, an IoT device.

The information processing apparatus 2 is a computer having a secure area 20 therein. The secure area 20 is a trusted execution environment (TEE) that is physically or logically separated from an area in the information processing apparatus outside the secure area 20 (hereinafter referred to as an “area outside the secure area”). The secure area 20 has a memory (not illustrated) whose access from a main process in the area outside the secure area is restricted and securely holds a secure program and various key information according to the present example embodiment. Thus, the secure area 20 is a TEE that is a more secure execution environment than the area outside the secure area in the information processing apparatus 2. Here, the information processing apparatus 2 is trusted hardware that is an anti-tamper device. Trusted hardware refers to a device that provides an isolated execution environment in which data in a memory cannot be referred to or altered even with root privileges on the operating system (OS). The secure area 20 can be implemented by technical specifications typified by TrustZone of the ARM (Registered trademark) architecture, Intel SGX, or the like.

The information processing apparatus 2 includes a storage unit 21, an authentication unit 221, a signature generation unit 222, an acquiring unit 223, and a transmitting unit 224. Here, the storage unit 21, the authentication unit 221 and the signature generation unit 222 are components in the secure area 20. The storage unit 21 stores a first common key 211 and a first private key 212. The first common key 211 is a common key for both the information processing apparatus 2 and the measuring apparatus 1. The first private key 212 is key information used as a signature key for digitally signing the measurement data out of a pair of a private key and a public key assigned to the measuring apparatus 1. The storage unit 21 may store the public key paired with the first private key 212.

The acquiring unit 223 acquires the communication data described above from the measuring apparatus 1. The authentication unit 221 authenticates the authentication code in the communication data using the first common key 211 in the secure area 20. When the authentication unit 221 has authenticated the authentication code, the signature generation unit 222 generates, for the measurement data in the communication data, a first digital signature using the first private key 212 in the secure area 20. The transmitting unit 224 transmits transaction data including the measurement data and the first digital signature to a predetermined node 3.

The node 3 is an information processing apparatus that performs recording in the blockchain 4. The node 3 includes a storage unit 31, a receiving unit 321, a verification unit 322, a signature generation unit 323, and a recording unit 324. The storage unit 31 stores the first public key 311. The first public key 311 is key information paired with the first private key 212 described above and has been assigned to the measuring apparatus 1.

The receiving unit 321 receives the transaction data described above from the information processing apparatus 2. The verification unit 322 verifies the first digital signature included in the transaction data using the first public key 311. When the verification unit 322 has verified the first digital signature, the signature generation unit 323 generates, for the transaction data, a node signature which is a digital signature. Here, the node signature is a digital signature required to write transaction data into the blockchain 4. It is assumed that a pair of a signature key (private key) and a verification key (public key) for the node signature has been generated in advance and the signature generation unit 323 holds the signature key for the node signature in advance. The recording unit 324 generates transaction data including the node signature. Here, the node 3 itself may generate a block. In this case, the node 3 records the block in the blockchain 4. Alternatively, the node 3 may send the transaction data to a P2P network and another node responsible for block generation may generate a block including the transaction data and record the block in the blockchain 4.

The blockchain 4 is a group of pieces of information that concatenates blocks that are sets of transactions and is ledger information that is distributed and managed on a network.

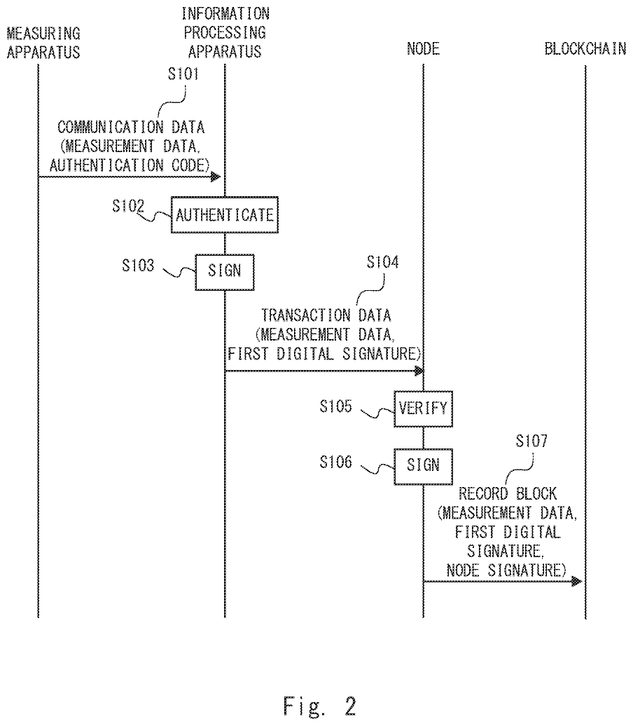

FIG. 2 is a sequence diagram illustrating a series of steps of a data recording process according to the first example embodiment. First, the acquiring unit 223 of the information processing apparatus 2 acquires communication data including measurement data and an authentication code from the measuring apparatus 1 (S101). Here, the authentication code is information that has been generated for the measurement data using the first common key in the measuring apparatus 1.

Next, the authentication unit 221 authenticates the authentication code in the communication data using the first common key 211 in the secure area 20 (S102). When the authentication code has been authenticated in step S102, the signature generation unit 222 generates, for the measurement data in the communication data, a first digital signature using the first private key 212 in the secure area (S103). Then, the transmitting unit 224 transmits transaction data including the measurement data and the first digital signature to the node 3 (S104).

Subsequently, the receiving unit 321 of the node 3 receives the transaction data from the information processing apparatus 2. Then, the verification unit 322 verifies the first digital signature included in the transaction data using the first public key 311 (S105). When the first digital signature has been verified in step S105, the signature generation unit 323 generates a node signature for the transaction data (S106). Then, the recording unit 324 generates a block including the transaction data and the node signature and records the block in the blockchain 4 (S107).

In the present example embodiment, first, measurement data is communicated between the measuring apparatus 1 and the information processing apparatus 2 using a common key cryptography and is signed in the information processing apparatus 2 using the first private key 212 assigned to the measuring apparatus 1a as described above. In particular, in the information processing apparatus 2, the authentication code of the measurement data is verified and the measurement data is signed in the secure area 20. Therefore, the node 3 can verify that the measurement data included in the received transaction data has been signed using key information assigned to the measuring apparatus 1. In addition, the node 3 applies its own signature (node signature) to the received transaction data, such that it can be recorded in the blockchain 4. This enables recording of measurement data from the measuring apparatus 1 in the blockchain 4 while maintaining its reliability.

The information processing apparatus 2 has a processor, a memory, and another storage device in each of the secure area 20 and the area outside the secure area as components which are not illustrated. The other storage device stores a secure program according to the present example embodiment and a computer program in which a data recording process (for the information processing apparatus 2) is implemented. Then, the processor in the secure area 20 loads the secure program into the memory in the secure area 20 and executes the computer program. Thus, the processor in the secure area 20 of the information processing apparatus 2 implements the functions of the authentication unit 221 and the signature generation unit 222. The processor in the area outside the secure area loads a data recording program into the memory in the area outside the secure area and executes the computer program. Thus, the processor in the area outside the secure area of the information processing apparatus 2 implements the functions of the acquiring unit 223 and the transmitting unit 224.

Alternatively, the authentication unit 221, the signature generation unit 222, the acquiring unit 223, and the transmitting unit 224 described above may be implemented by dedicated hardware. Some or all of the components such as the authentication unit 221 may also be implemented by a general-purpose or dedicated circuitry, a processor, or the like or a combination thereof. Such implementation may be implemented using a single chip or may be implemented using a plurality of chips connected via a bus. Some or all of the components of each apparatus may be implemented by a combination of the circuitry or the like described above and a program. A central processing unit (CPU), a graphics processing unit (GPU), a field-programmable gate array (FPGA), an ARM (Registered trademark) architecture, Intel software guard extensions (SGX), or the like can also be used as a processor.

Further, the node 3 has a processor, a memory, and a storage device as components which are not illustrated. The storage device stores a computer program in which a data recording process (for the node 3) according to the present example embodiment is implemented. Then, the processor loads the computer program from the storage device into the memory and executes the computer program. Thus, the processor implements the functions of the receiving unit 321, the verification unit 322, the signature generation unit 323, and the recording unit 324.

Alternatively, the receiving unit 321, the verification unit 322, the signature generation unit 323, and the recording unit 324 may each be implemented by dedicated hardware. Some or all of the components of each apparatus may also be implemented by a general-purpose or dedicated circuitry, a processor, or the like or a combination thereof. Such implementation may be implemented using a single chip or may be implemented using a plurality of chips connected via a bus. Some or all of the components of each apparatus may be implemented by a combination of the circuitry or the like described above and a program. A central processing unit (CPU), a graphics processing unit (GPU), a field-programmable gate array (FPGA), or the like can also be used as a processor.

Further, when some or all of the components of the node 3 are each implemented by a plurality of information processing apparatuses, circuits, and the like, the plurality of information processing apparatuses, circuits, and the like may be centrally arranged or may be distributed. For example, the information processing apparatuses, the circuits, and the like may be implemented in a form in which they are connected via a communication network, such as in a client-server system or a cloud computing system.

### Second Example Embodiment

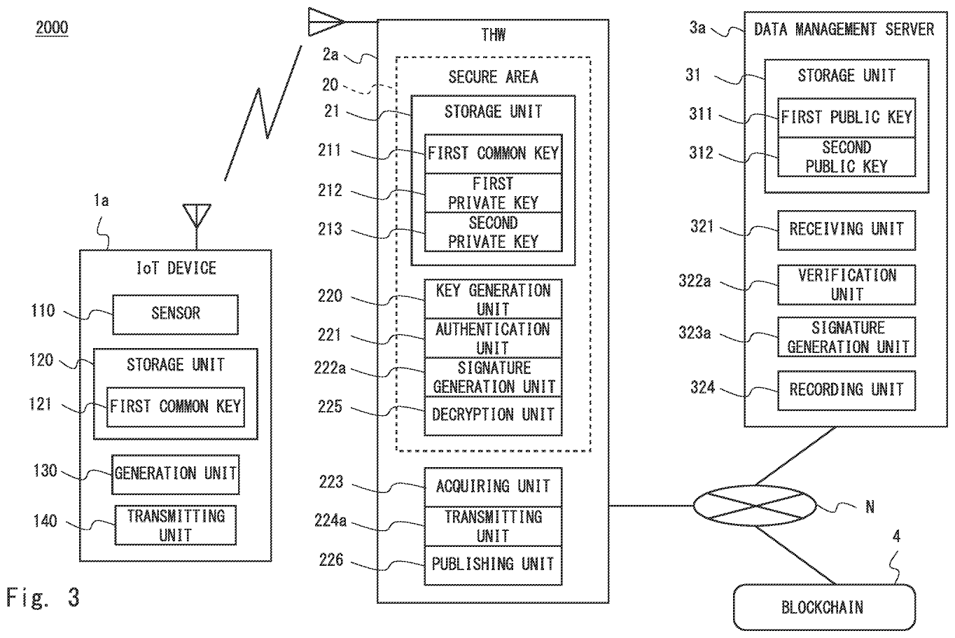

FIG. 3 is a block diagram illustrating an overall configuration of a data recording system 2000 according to a second example embodiment. The data recording system 2000 includes an IoT device 1a, trusted hardware (THW) 2a, a data management server 3a, and a blockchain 4. Here, at least the THW 2a, the data management server 3a, and the blockchain 4 are connected via a network N. The IoT device 1a may also be connected to the network N. Here, the network N is a communication line such as the Internet.

The IoT device 1a is an example of the measuring apparatus 1 described above and includes a sensor 110, a storage unit 120, a generation unit 130, and a transmitting unit 140. The sensor 110 performs predetermined measurement and generates (measures and acquires) sensor data (measurement data). Here, examples of sensor data include the temperature and humidity of a container transported for managing fresh food. Another example is global positioning system (GPS) data to prove that fishing was done in a permitted sea area. Another example is electricity usage data from smart meters attached to homes or electrical appliances for electricity transactions. Other examples include records (such as heater temperatures) of the manufacturing processes of parts (such as tires, car bodies, and glass windows) of automobiles. Sensor data used in supply chain management can also be applied. Examples of the IoT device 1a include, but are not limited to, a temperature sensor, a humidity sensor, a GPS receiver, and a power meter.

The storage unit 120 stores a first common key 121. The first common key 121 is a common key for both the IoT device 1a and the THW 2a. That is, the first common key 121 is the same key information as the first common key 211. The generation unit 130 generates, for the measurement data, an authentication code using the first common key 121. For example, a message authentication code (MAC) can be used as the authentication code. The transmitting unit 140 transmits communication data including the authentication code and measurement data to the THW 2a. That is, the communication data can be referred to as at least data with an authentication attached thereto, <data, MAC>.

Here, the generation unit 130 according to the present example embodiment may generate encrypted data and an authentication tag by encrypting the measurement data through authenticated encryption using the first common key 121 instead of using a MAC. Examples of an authentication encryption protocol that can be used here include, but are not limited to, an AES-Galois/counter mode (AES-GCM) and an AES-counter with CBC-MAC (AES-CCM). The authentication tag can also be called an authentication code. In this case, the communication data can be referred to as encrypted data with an authentication attached thereto, <header, enc_k(data), tag>. Here, header is header information of the communication data and enc_k( ) indicates encryption using the first common key 121. In addition, tag indicates the authentication tag. Further, the header may include identification information or the like of the IoT device 1a.

The IoT device 1a includes a processor, a memory, and a storage device as components that are not illustrated. The storage device stores a computer program in which the processing of the IoT device 1a according to the present example embodiment is implemented. Then, the processor loads the computer program from the storage device into the memory and executes the computer program. Thus, the processor implements the functions of the generation unit 130 and the transmitting unit 140.

Alternatively, the generation unit 130 and the transmitting unit 140 may each be implemented by dedicated hardware. Some or all of the components of each apparatus may also be implemented by a general-purpose or dedicated circuitry, a processor, or the like or a combination thereof. Such implementation may be implemented using a single chip or may be implemented using a plurality of chips connected via a bus. Some or all of the components of each apparatus may be implemented by a combination of the circuitry or the like described above and a program. A CPU, a GPU, an FPGA, or the like can also be used as a processor.

The THW 2a is an example of the information processing apparatus 2 described above and is trusted hardware that is an anti-tamper device. Examples of the THW 2a include a mobile terminal such as a smartphone or a tablet terminal for collecting measurement data from the IoT device 1a or a personal computer (PC). Compared to the information processing apparatus 2, the THW 2a has a second private key 213, a key generation unit 220, and a decryption unit 225 added to the secure area 20 and includes a signature generation unit 222a instead of the signature generation unit 222. Also, compared to the information processing apparatus 2, the THW 2a has a publishing unit 226 added to the area outside the secure area and includes a transmitting unit 224a instead of the transmitting unit 224. Because the other components are similar to those of FIG. 1, the same reference signs are given to them and duplicate description will be omitted as appropriate.

The storage unit 21 in the secure area 20 further stores the second private key 213. The second private key 213 is key information used as a signature key for digitally signing the measurement data out of a pair of a private key and a public key assigned to the THW 2a.

The key generation unit 220 generates a pair of the first private key 212 and the first public key 311 in the secure area 20. For example, the key generation unit 220 generates a pair of the first private key 212 and the first public key 311 in response to receiving first identification information of the IoT device 1a. Here, the first public key 311 is key information paired with the first private key 212 and is a verification key for verifying a digital signature generated using the first private key 212. Then, the key generation unit 220 assigns the first private key 212 to the first identification information and stores the first private key 212 assigned to the first identification information in the storage unit 21. The key generation unit 220 outputs a pair of the first public key 311 and the first identification information to the area outside the secure area.

Further, the key generation unit 220 generates a pair of the second private key 213 and a second public key 312 in the secure area 20. For example, the key generation unit 220 generates a pair of the second private key 213 and the second public key 312 in response to receiving second identification information of the THW 2a. Here, the second public key 312 is key information paired with the second private key 213 and is a verification key for verifying a digital signature generated using the second private key 213. Then, the key generation unit 220 assigns the second private key 213 to the second identification information and stores the second private key 213 assigned to the second identification information in the storage unit 21. The key generation unit 220 outputs a pair of the second public key 312 and the second identification information to the area outside the secure area. The key generation unit 220 does not output the first private key 212 and the second private key 213 to the area outside the secure area.

The key generation unit 220 may generate a first common key 211 and store the first common key 211 in the storage unit 21. In this case, it is assumed that the IoT device 1a acquires the first common key 211 through a secure method and stores it in the storage unit 120 as a first common key 121.

The publishing unit 226 publishes the pair of the first public key 311 and the first identification information output by the key generation unit 220 outside. The publishing unit 226 also publishes the pair of the second public key 312 and the second identification information output by the key generation unit 220 outside. Here, “publishing” is, for example, setting a specific storage area in the THW 2a to be accessible from outside the THW 2a and storing the first public key 311 and the second public key 312 in the storage area. Alternatively, “publishing” is, for example, uploading the first public key 311 and the second public key 312 to a file server accessible from any computer on the network. Specifically, the publishing unit 226 may record the pair of the first public key 311 and the first identification information and the pair of the second public key 312 and the second identification information in the blockchain 4 via the network N. Thus, the data management server 3a can acquire the first public key 311 and the second public key 312. Alternatively, the publishing unit 226 may transmit the first public key 311 and the second public key 312 to at least the data management server 3a to publish them.

The acquiring unit 223 acquires communication data directly from the IoT device 1a through wireless or wired communication. The acquiring unit 223 may receive the communication data transmitted from the IoT device 1a to acquire the communication data or may access the IoT device 1a to acquire the communication data.

The authentication unit 221 authenticates the authentication code in the communication data using the first common key 211 in the secure area 20.

When the authentication unit 221 has authenticated the authentication code, the decryption unit 225 decrypts, in the secure area 20, the encrypted data in the communication data to the measurement data using the first common key 211.

The signature generation unit 222a generates, for the decrypted measurement data, a first digital signature using the first private key 211 in the secure area 20. Then, the signature generation unit 222a further generates, in the secure area 20, a second digital signature for the measurement data and the first digital signature using the second private key 213. Here, an elliptic curve digital signature algorithm (ECDSA) or the like can be used for the first and second digital signatures.

The transmitting unit 224a further includes the second digital signature in the transaction data and transmit the resultant transaction data to the data management server 3a via the network N. Thereby, the reliability of the THW 2a itself can be proven to the data management server 3a.

The data management server 3a is an example of the node 3 described above and is an information processing apparatus that performs verification, signing, and the like on transaction data received from the THW 2a and records the transaction data in the blockchain 4. Compared to the node 3, the data management server 3a has a second public key 312 added to the storage unit 31 and includes a verification unit 322a and a signature generation unit 323a instead of the verification unit 322 and the signature generation unit 323. Because the other components are similar to those of FIG. 1, the same reference signs are given to them and duplicate description will be omitted as appropriate.

The first public key 311 and the second public key 312 are the key information described above that has been published by the publishing unit 226, acquired by the data management server 3a, and stored in the storage unit 31.

Similar to the verification unit 322 described above, the verification unit 322a further verifies the first digital signature included in the transaction data using the first public key 311 and further verifies the second digital signature included in the transaction data using the second public key 312. The signature generation unit 323a generates a node signature when the first and second digital signatures have been verified.

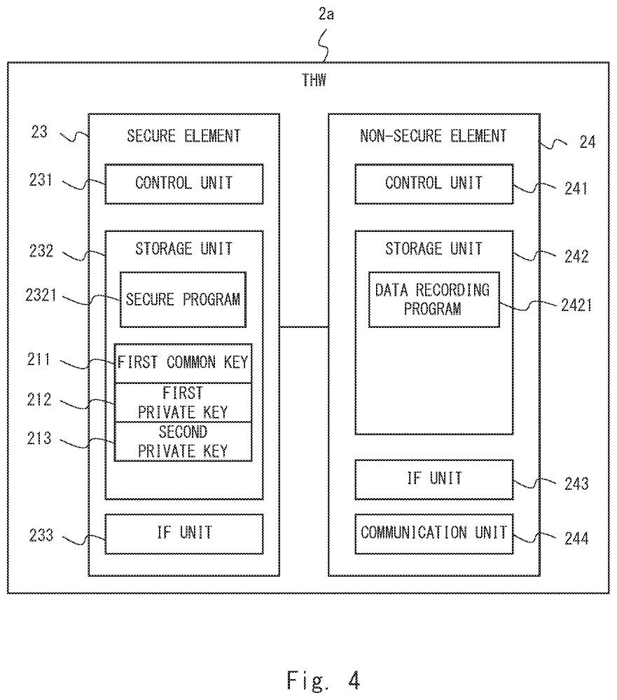

FIG. 4 is a block diagram illustrating a hardware configuration of the trusted hardware according to the second example embodiment. The THW 2a includes a secure element 23 and a non-secure element 24. The secure element 23 corresponds to the secure area 20 described above and the non-secure element 24 corresponds to the area outside the secure area. The non-secure element 24 is a main portion of the THW 2a and implements many functions of the THW 2a. The secure element 23 is hardware that is physically or logically separated from the non-secure element 24. The secure element 23 is a more secure execution environment than the non-secure element 24 and is implemented, for example, by the TEE described above.

The secure element 23 includes a control unit 231, a storage unit 232, and an interface (IF) unit 233. The control unit 231 is a processor, that is, a control device that controls each component of the secure element 23. For example, the control unit 231 may be implemented by one or more processor cores. The storage unit 232 is a storage area for temporarily holding information during operation of the control unit 231. The storage unit 232 is, for example, a volatile storage device such as a random access memory (RAM) or a non-volatile storage device such as a flash memory. The storage unit 232 stores a secure program 2321 loaded from the non-secure element 24. The secure program 2321 is a computer program in which the processing of the key generation unit 220, the authentication unit 221, the signature generation unit 222a, and the decryption unit 225 is implemented. The storage unit 232 stores the first common key 211, the first private key 212, and the second private key 213. The first private key 212 and the second private key 213 are generated at least in the secure element 23. The IF unit 233 is an interface for inputting and outputting information to and from the non-secure element 24. The control unit 231 executes the secure program 2321 loaded in the storage unit 232 to implement the functions of the key generation unit 220, the authentication unit 221, the signature generation unit 222a, and the decryption unit 225 described above.

The non-secure element 24 includes a control unit 241, a storage unit 242, an IF unit 243, and a communication unit 244. The control unit 241 is a processor, that is, a control device that controls each component of the non-secure element 24. For example, the control unit 241 may be implemented by one or more processor cores. The storage unit 242 is a storage area for temporarily holding information during operation of the control unit 241. The storage unit 232 is, for example, a volatile storage device such as a RAM or a non-volatile storage device such as a flash memory. The storage unit 242 stores a data recording program 2421 loaded from the control unit 241. The data recording program 2421 is a computer program in which the processing of the acquiring unit 223, the transmitting unit 224a, and the publishing unit 226 is implemented. The IF unit 243 is an interface for inputting and outputting information to and from the secure element 23. The communication unit 244 includes a processing circuit, an antenna, and the like for performing processing relating to communication with the outside. The communication unit 244 transmits and receives information to and from the IoT device 1a and also transmits and receives information to and from the data management server 3a and the like via the network N. The control unit 241 executes the data recording program 2421 loaded in the storage unit 242 to implement the functions of the acquiring unit 223, the transmitting unit 224a, and the publishing unit 226 described above.

The secure element 23 described above may be isolated from other processing areas in hardware or may be isolated from other processing areas in software.

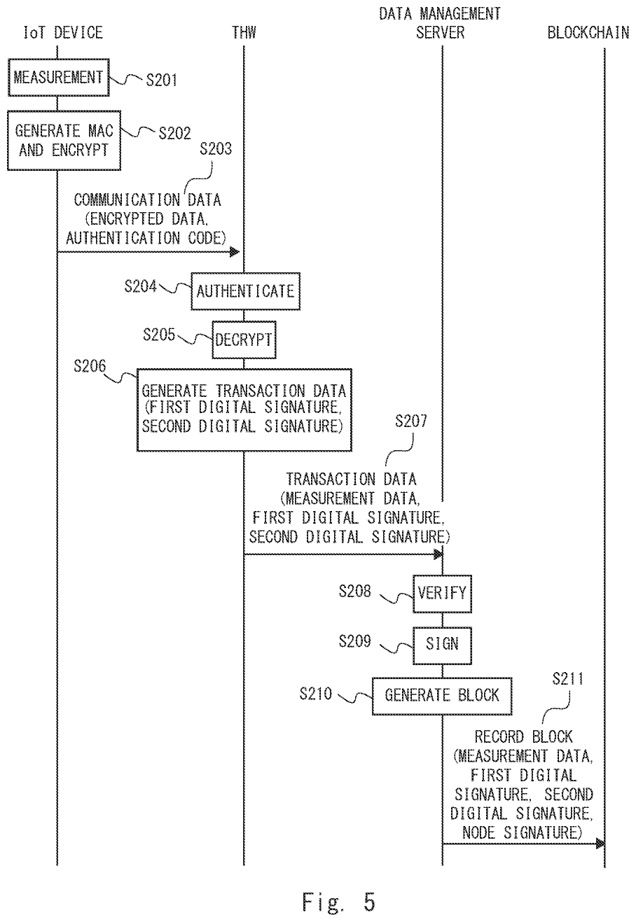

FIG. 5 is a sequence diagram illustrating a series of steps of a data recording process according to the second example embodiment. First, the sensor 110 of the IoT device 1a performs measurement (S201) and generates measurement data. Next, the generation unit 130 generates, for the measurement data, a MAC using the first common key 121 and encrypts the measurement data (S202). After that, the transmitting unit 140 transmits communication data including the encrypted data and the authentication code to the THW 2a (S203). For example, the sensor 110 may perform measurement at regular intervals and the transmitting unit 140 may transmit communication data each time measurement is performed. In response to this, the acquiring unit 223 of the THW 2a receives, that is, acquires, communication data from the IoT device 1a.

Then, the authentication unit 221 authenticates the authentication code in the communication data using the first common key 211 in the secure area 20 (S204). When the authentication code has been authenticated in step S204, the decryption unit 225 decrypts, in the secure area 20, the encrypted data in the communication data to the measurement data using the first common key 211 (S205). Then, the signature generation unit 222a generates, in the secure area 20, a first digital signature for the decrypted measurement data using the first private key 211. Then, the signature generation unit 222a generates, in the secure area 20, a second digital signature for the measurement data and the first digital signature using the second private key 213. Then, the signature generation unit 222a generates transaction data including the measurement data (data), the first digital signature (σ_iot), and the second digital signature (σ_thw) (S206). Here, the transaction data can be expressed as “<(data, ID_iot), σ_iot, σ_thw>.” In this case, ID_iot is the first identification information of the IoT device 1a.

After that, the transmitting unit 224a transmits the transaction data to the data management server 3a via the network N (S207). In response to this, the receiving unit 321 of the data management server 3a receives the transaction data from the THW 2a via the network N.

Then, the verification unit 322a further verifies the first digital signature included in the transaction data using the first public key 311 and further verifies the second digital signature included in the transaction data using the second public key 312 (S208). When the first and second digital signatures have been verified in step S208, the signature generation unit 323a generates, for the transaction data, a node signature using its own signature key (S209).

The recording unit 324 performs hash value calculation, generation of a block including the transaction data and the node signature (S210), consensus building, and the like and records the block in the blockchain 4 (S211).

In the second example embodiment, use of the THW 2a allows measurement data measured by the IoT device 1a to be recorded in the blockchain 4 without losing the reliability of the measurement data as described above, similar to the first example embodiment. Further, inclusion of the second digital signature in the transaction data can ensure the reliability of the transaction data in the block even when the data management server 3a is unreliable.

### Third Example Embodiment

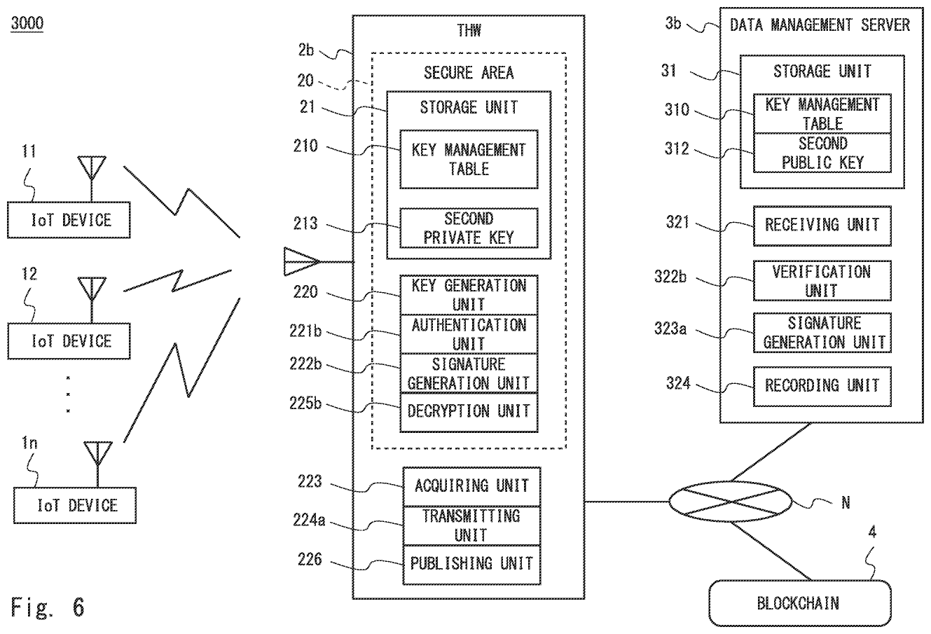

FIG. 6 is a block diagram illustrating an overall configuration of a data recording system 3000 according to a third example embodiment. The data recording system 3000 includes IoT devices 11, 12, . . . , 1n (where n is a natural number of 2 or more), a THW 2b, a data management server 3b, and a blockchain 4. Here, at least the THW 2b, the data management server 3b, and the blockchain 4 are connected via the network N. The IoT devices 11 and the like may also be connected to the network N.

Each of the IoT devices 11 to 1n has a configuration similar to that of the IoT device 1a described above except that identification information of the IoT devices 11 to 1n differs from each other. In this case, the IoT devices 11 to 1n can be measuring apparatuses that are installed at different locations and measure similar sensor data. Alternatively, the IoT devices 11 to 1n may be equipped with different sensors 110. In this case, the sensors measure data of different indicators such as temperature and humidity.

The THW 2b is an improvement of the THW 2a described above, and compared to the THW 2a, has a key management table 210 in the storage unit 21 and includes an authentication unit 221b instead of the authentication unit 221 and a signature generation unit 222b instead of the signature generation unit 222a. Because the other components are similar to those of FIG. 3, the same reference signs are given to them and duplicate description will be omitted as appropriate.

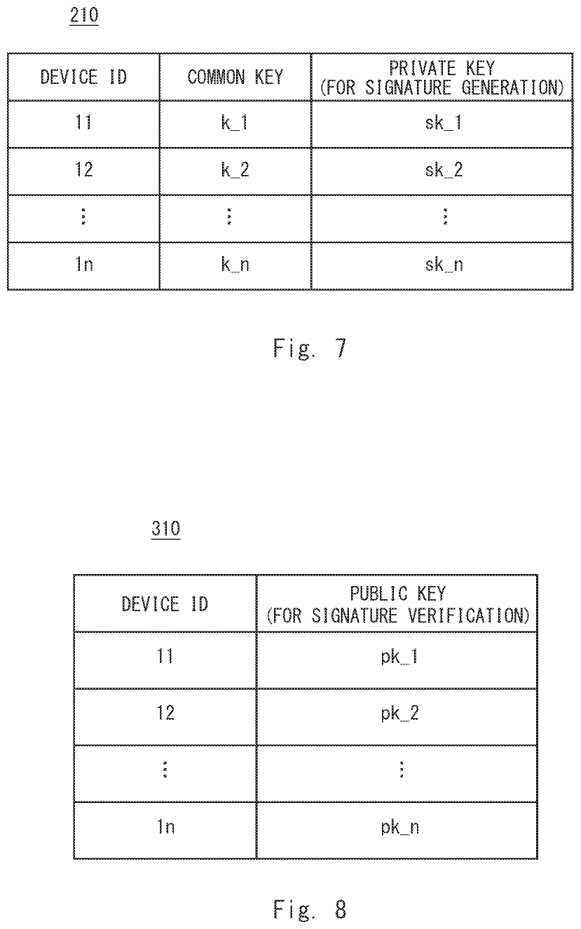

The key management table 210 is a table for managing pairs of the first common key 211 and the first private key 212 corresponding to the IoT devices by associating (assigning) the pairs of the first common key 211 and the first private key 212 with (to) the identification information of the IoT devices. FIG. 7 is a diagram illustrating an example of the key management table 210 of the THW 2b according to the third example embodiment. FIG. 7 indicates, for example, that a common key “k_1” and a private key “sk_1” are associated with a device ID “11.”

The authentication unit 221b refers to the key management table 210 and authenticates an authentication code using a first common key assigned to an IoT device from which the communication data has been acquired. The signature generation unit 222b refers to the key management table 210 and generates a first digital signature using a first private key assigned to the IoT device from which the communication data has been acquired.

The data management server 3b is an improvement of the data management server 3a described above, and compared to the data management server 3a, has a key management table 310 in the storage unit 31 and includes a signature generation unit 323b instead of the signature generation unit 323a. Because the other components are similar to those of FIG. 3, the same reference signs are given to them and duplicate description will be omitted as appropriate.

The key management table 310 is a table for managing first public keys 311 corresponding to the IoT devices by associating (assigning) the first public keys 311 with (to) the identification information of the IoT devices. FIG. 8 is a diagram illustrating an example of the key management table 310 of the data management server 3b according to the third example embodiment. FIG. 8 indicates, for example, that a public key “pk_1” is associated with a device ID “11.”

The verification unit 322b identifies identification information of an IoT device corresponding to measurement data included in transaction data and refers to the key management table 210 to read a first public key 311 corresponding to the identified identification information. Then, the verification unit 322b verifies a first digital signature included in the transaction data using the read first public key 311.

According to the third example embodiment, measurement data can be collected from two or more IoT devices and recorded in the blockchain while ensuring the reliability as described above.

### Fourth Example Embodiment

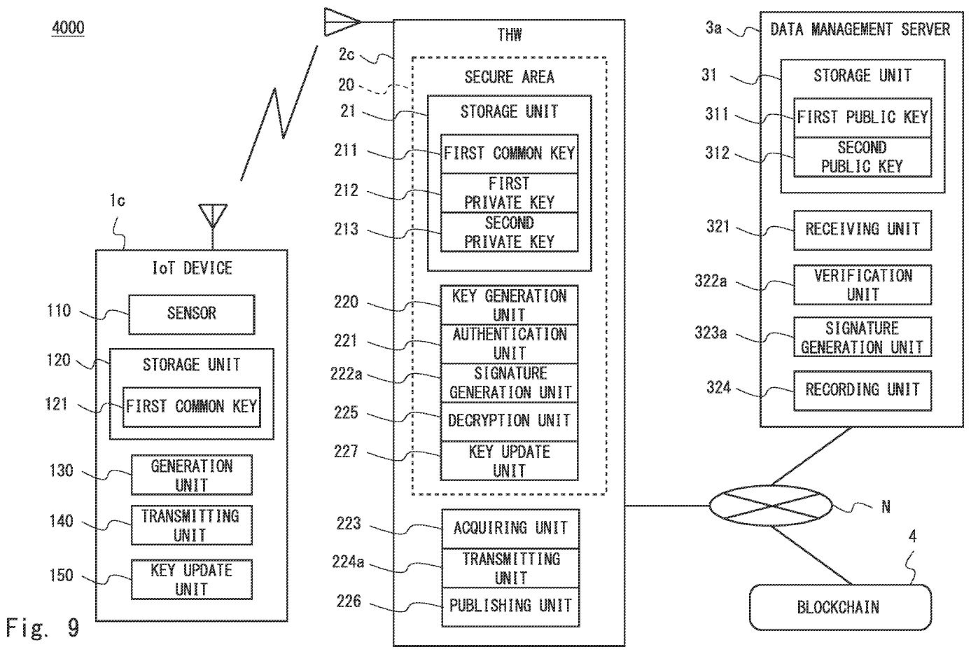

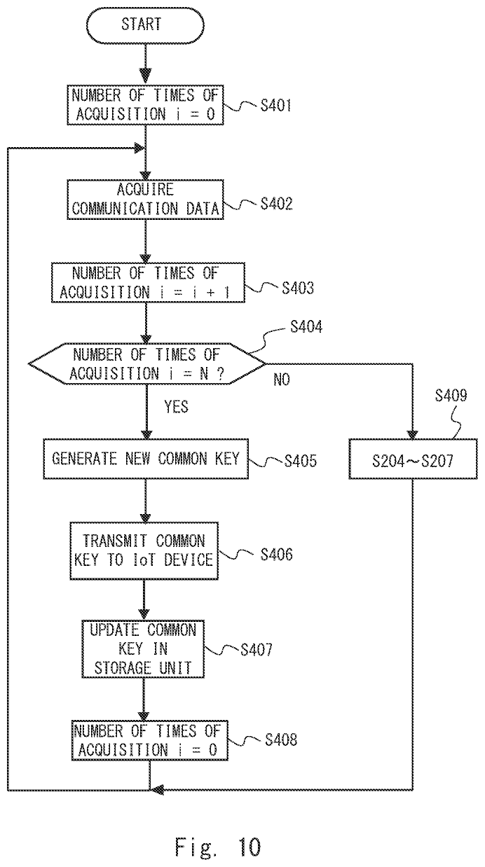

FIG. 9 is a block diagram illustrating an overall configuration of a data recording system 4000 according to a fourth example embodiment. Compared to the data recording system 2000 described above, the data recording system 4000 includes an IoT device 1c and a THW 2c instead of the IoT device 1a and the THW 2a. Because the other components are similar to those of FIG. 3, the same reference signs are given to them and duplicate description will be omitted as appropriate.

The THW 2c includes a key update unit 227 in addition to the components of the THW 2a described above. The key update unit 227 generates a second common key in the secure area 20 each time the number of times communication data is acquired from the IoT device 1c reaches a predetermined number of times. Then, the key update unit 227 transmits the second common key to the IoT device 1c to cause the IoT device 1c to update the first common key 121. At this time, the key update unit 227 may use the first common key 211 to encrypt and transmit the second common key. For example, the key update unit 227 turns on a key update flag (KEY_UPDATE_FLAG), encrypts a pair of an initialization vector (IV_new) and the second common key (k_new) using the first common key 211, and transmits the encrypted data to the IoT device 1c as a key update request. After that, the key update unit 227 updates, in the storage unit 21, the first common key 211 to the second common key. Here, it is assumed that the “predetermined number of times” has been appropriately determined according to the type and application of the IoT device 1c (sensor) or sensor data (communication data). Then, it is assumed that the THW 2c has stored the value of the predetermined number of times in the storage unit 21 or the like in advance.

The IoT device 1c includes a key update unit 150 in addition to the components of the IoT device 1a described above. Upon receiving the second common key from the THW 2c, the key update unit 150 updates the first common key 121 in the storage unit 120 to the second common key. For example, upon receiving a key update request from the THW 2c, the key update unit 150 decrypts the key update request using the first common key 121 to acquire a second common key and an initialization vector and stores the second common key and the initialization vector in the storage unit 120.

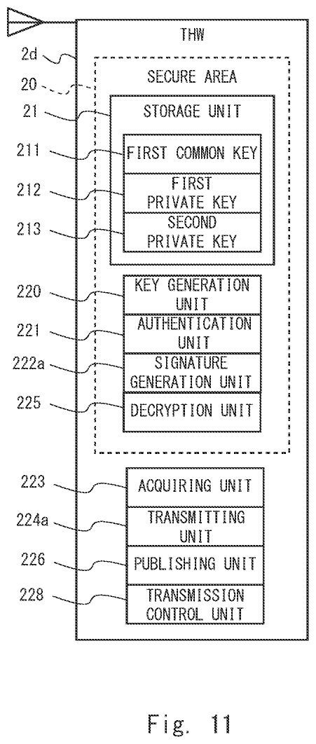

FIG. 10 is a flowchart illustrating a series of steps of a key update process according to the fourth example embodiment. First, the key update unit 227 of the THW 2c sets the number of times of acquisition i equal to 0 (S401). Next, the acquiring unit 223 acquires communication data from the IoT device 1c (S402). Then, the key update unit 227 adds 1 to the number of times of acquisition i (S403). After that, the key update unit 227 determines whether the number of times of acquisition i is a predetermined number of times N (where N is a natural number of 2 or more) (S404). When the number of times of acquisition i is the predetermined number of times N, the key update unit 227 generates a new common key (a second common key) (S405). Then, the key update unit 227 transmits the second common key to the IoT device 1c through a secure channel (S406). After that, the key update unit 227 clears the number of times of acquisition i to be set equal to 0 (S408).

On the other hand, when the number of times of acquisition i is not the predetermined number of times N in step S404, that is, when the number of times of acquisition i is less than the predetermined number of times N, the THW 2c performs the processing of steps S204 to S207 of FIG. 5 described above (S409). After step S408 and S409, the process returns to step S402.

In a modification of the present example embodiment, a process of generating a new common key may be performed by the IoT device. In this case, the key update unit 150 generates a second common key each time the number of times communication data is transmitted to the THW 2c reaches a predetermined number of times. Then, the key update unit 150 transmits the second common key to the THW 2c to cause it to update the first common key 211. After that, the key update unit 150 updates, in the storage unit 120, the first common key 212 to the second common key.

Here, use of the same encryption key for a long period of time is not desirable in terms of security. Thus, it is necessary to update the encryption key as appropriate. Therefore, in the present example embodiment, the common key is updated each time the number of times communication data is transmitted or received reaches a predetermined number of times, such that the security of the common key can be improved.

### Fifth Example Embodiment

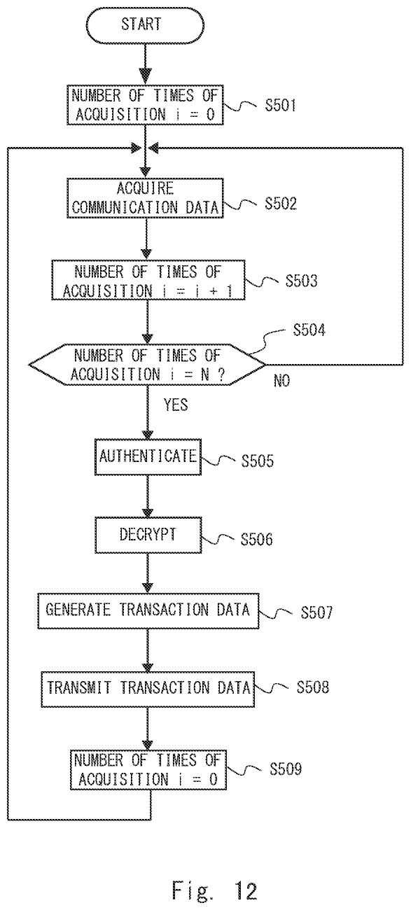

A fifth example embodiment is an improvement on the THW 2a according to the second example embodiment described above. FIG. 11 is a block diagram illustrating a configuration of trusted hardware (THW) 2d according to the fifth example embodiment. Compared to the THW 2a, the THW 2d further includes a transmission control unit 228. Because the other components are similar to those of FIG. 3, the same reference signs are given to them and duplicate description will be omitted as appropriate.

The transmission control unit 228 causes the transmitting unit 224a to transmit transaction data each time the number of times communication data is acquired from the IoT device 1a reaches a predetermined number of times.

FIG. 12 is a flowchart illustrating a series of steps of a data recording process according to the fifth example embodiment. First, the transmission control unit 228 of the THW 2d sets the number of times of acquisition i equal to 0 (S501). Next, the acquiring unit 223 acquires communication data from the IoT device 1a (S502). Then, the transmission control unit 228 adds 1 to the number of times of acquisition i (S503). After that, the transmission control unit 228 determines whether the number of times of acquisition i is a predetermined number of times N (S504). When the number of times of acquisition i is the predetermined number of times N, the authentication unit 221 authenticates an authentication code in the communication data using the first common key 211 in the secure area 20 (S505). When the authentication code has been authenticated in step S505, the decryption unit 225 decrypts, in the secure area 20, encrypted data in the communication data to measurement data using the first common key 211 (S506). Then, the signature generation unit 222a performs signing twice as described above and generates transaction data (S507). That is, the transaction data includes the measurement data acquired at the Nth time and does not include measurement data acquired up to the N−1th time. After that, the transmitting unit 224a transmits the transaction data to the data management server 3a via the network N (S508). After that, the transmission control unit 228 clears the number of times of acquisition i to be set equal to 0 (S509). Then, the process returns to step S502.

When the number of times of acquisition i is not the predetermined number of times N in step S504, that is, when the number of times of acquisition i is less than the predetermined number of times N, the process returns to step S502. Therefore, transaction data including measurement data up to the N−1th time is not transmitted to the data management server 3a.

Here, note that step S504 is executed after step S503 and before step S508.

As described above, the THW 2d according to the fifth example embodiment writes transaction data based on acquired communication data (measurement data) to the blockchain 4 only once every N times rather than writing the transaction data into the blockchain 4 each time. That is, it can be said that the frequency of writing into the blockchain 4 is controlled. Thus, the capacity of the blockchain 4 can be limited. Further, the number of times transaction data of the THW 2d is transmitted is also limited, the load on the network N is reduced, and processing load on the THW 2d is also reduced. Further, performing the determination at the position of step S504 can limit unnecessary decryption processing and signature generation processing and further reduces the processing load on the THW 2d.

### Sixth Example Embodiment

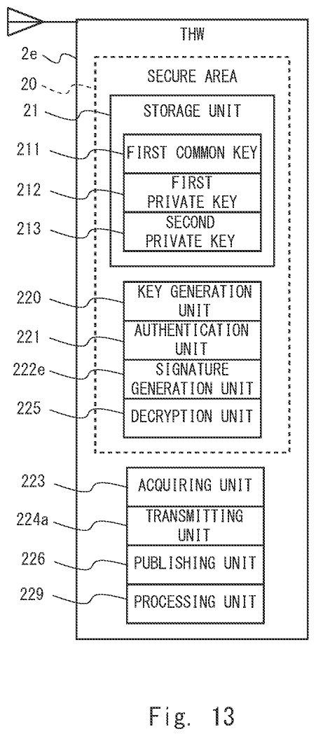

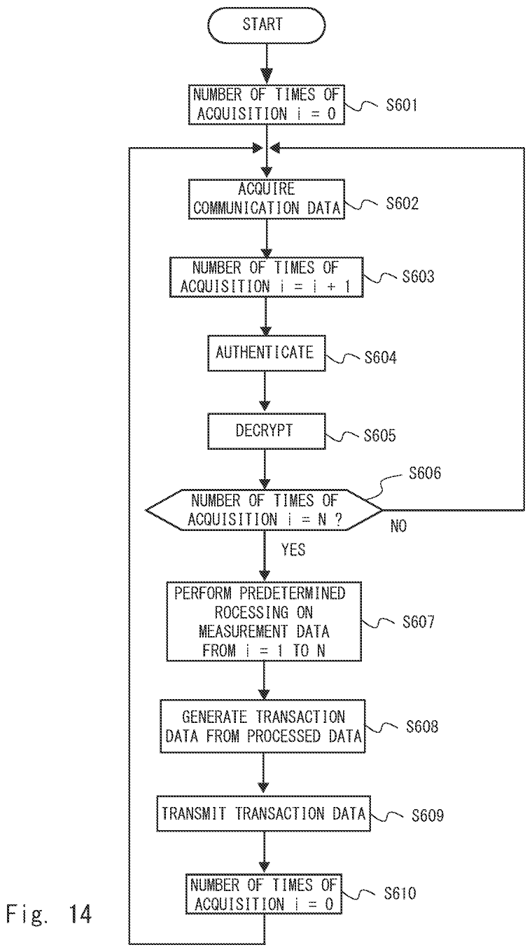

A sixth example embodiment is an improvement on the THW 2a according to the second example embodiment described above. FIG. 13 is a block diagram illustrating a configuration of trusted hardware (THW) 2e according to the sixth example embodiment. Compared to the THW 2a, the THW 2e further includes a processing unit 229 and includes a signature generation unit 222e instead of the signature generation unit 222. Because the other components are similar to those of FIG. 3, the same reference signs are given to them and duplicate description will be omitted as appropriate.

Each time the number of times communication data is acquired from the IoT device 1a reaches a predetermined number of times, the processing unit 229 performs predetermined processing on the predetermined number of pieces of measurement data in the predetermined number of pieces of communication data that have been acquired most recently. The predetermined processing is, for example, arithmetic processing for calculating an average value of a predetermined number of pieces of measurement data or processing for concatenating a predetermined number of pieces of measurement data into one piece of data. The predetermined processing may also be arithmetic processing such as various statistical processing. The signature generation unit 222e generates, in the secure area 20, a first digital signature for the processed data obtained through the processing using the first private key 212.

FIG. 14 is a flowchart illustrating a series of steps of a data recording process according to the sixth example embodiment. First, the processing unit 229 of the THW 2e sets the number of times of acquisition i equal to 0 (S601). Next, the acquiring unit 223 acquires communication data from the IoT device 1a (S602). Then, the processing unit 229 adds 1 to the number of times of acquisition i (S603). The authentication unit 221 authenticates an authentication code in the communication data using the first common key 211 in the secure area 20 (S604). When the authentication code has been authenticated in step S604, the decryption unit 225 decrypts, in the secure area 20, encrypted data in the communication data into measurement data using the first common key 211 (S605). After that, the processing unit 229 determines whether the number of times of acquisition i is a predetermined number of times N (S606).

When the number of times of acquisition i is not the predetermined number of times N in step S606, that is, when the number of times of acquisition i is less than the predetermined number of times N, the process returns to step S602. When the number of times of acquisition i is the predetermined number of times N in step S606, the processing unit 229 performs predetermined processing on pieces of measurement data from i=1 to N (S607) and generates one piece of processed data. For example, when the IoT device 1a transmits temperature measurement data every 5 minutes, the processing unit 229 receives 12 pieces of measurement data (communication data) in one hour. Therefore, in this case, the processing unit 229 calculates an average value of 12 pieces of temperature measurement data each time communication data is acquired 12 times.

Subsequently, the signature generation unit 222e generates transaction data from the processed data (S608). Specifically, the signature generation unit 222e generates, in the secure area 20, a first digital signature for the processed data using the first private key 211. Then, the signature generation unit 222e generates, in the secure area 20, a second digital signature for the processed data and the first digital signature using the second private key 213. Then, the signature generation unit 222a generates transaction data including the processed data, the first digital signature, and the second digital signature. After that, the transmitting unit 224a transmits the transaction data to the data management server 3a via the network N (S609) and then the processing unit 229 clears the number of times of acquisition i to be set equal to 0 (S408). Then, the process returns to step S602.

In the sixth example embodiment, as described above, the transaction data is less frequently written into the blockchain 4 and the measurement data is processed into processed data which has a reasonable value to some extent. This is useful when utilizing the processed data in the transaction data. Further, the number of times transaction data of the THW 2e is transmitted is also limited, the load on the network N is reduced, and processing load on the THW 2d is also reduced.

### Other Example Embodiments

The third example embodiment may be changed as follows. First, it is assumed that the acquiring unit 223 acquires first communication data from a first measuring apparatus and second communication data from a second measuring apparatus within a predetermined time. At the same time, it is assumed that the authentication unit 221b has authenticated a first authentication code in the first communication data and a second authentication code in the second communication data. In such a case, for first measurement data in the first communication data and second measurement data in the second communication data, the signature generation unit 222b generates, in the secure area 20, a first digital signature using a first private key 212. Here, it is assumed that the first private key 212 has been assigned to a pair of the first measuring apparatus and the second measuring apparatus. Then, in this case, the transmitting unit 224a transmits transaction data including the first measurement data, the second measurement data, and the first digital signature to the data management server 3b. Incorporating sensor data of a plurality of indicators (for example, temperature and GPS data) measured within a predetermined time into one piece of transaction data allows the sensor data to be efficiently utilized.

Transaction data may also be generated according to the amount of acquired data instead of generating transaction data according to the number of times data is acquired as in the sixth example embodiment described above. For example, the processing unit may perform, each time the amount of communication data acquired from the IoT device reaches a predetermined amount, predetermined processing on measurement data in the predetermined amount of communication data that has been acquired most recently. In addition, the THW may move to collect measurement data from a plurality of IoT devices through wireless communication, and after returning to the original location, collectively generate processed data and transaction data and write it into the blockchain. For example, when the respective records of sensor data of the manufacture, shipment, and transportation of purchased products are referred to from the blockchain in a supermarket, it does not matter if the records are collectively written. This is because their real-time property can be considered relatively low. On the other hand, when the transporting agent records temperature management and the like of transported goods, it is desirable to record them in the blockchain each time. This is because their real-time property can be considered relatively high.

In the above example embodiment, the elements described in the drawings as functional blocks that perform various processing can each be implemented by hardware using a central processing unit (CPU), a memory, and other circuits and can be implemented by software using a program or the like that a CPU loads and executes in a memory. Thus, it will be understood by those skilled in the art that such functional blocks can be implemented in various forms, using but not limited to hardware only, software only, or a combination thereof.

The program described above can be stored and provided to a computer using various types of non-transitory computer readable media. Non-transitory computer readable media include various types of tangible storage media. Examples of non-transitory computer readable media include magnetic storage media (for example, a flexible disk, a magnetic tape, and a hard disk drive), magneto-optical storage media (for example, a magneto-optical disc), a compact disc read-only memory (CD-ROM), a CD-recordable (CD-R), a CD-rewritable (CD-R/W), and semiconductor memories (for example, a mask ROM, a programmable ROM (PROM), an erasable PROM (EPROM), a flash ROM, and a random access memory (RAM)). The program may be provided to a computer using various types of transitory computer readable media. Examples of transitory computer readable media include electric signals, optical signals, and electromagnetic waves. Transitory computer readable media can provide the program to a computer via a wired communication line such as an electric wire or an optical fiber or a wireless communication line.

The present disclosure is not limited to the above example embodiments and can be modified as appropriate without departing from the gist. The present disclosure may also be carried out by appropriately combining the example embodiments.

Some or all of the above example embodiments may be described as in but not limited to the following supplements.

(Supplement A1)

An information processing apparatus including:

a storage unit in a secure area, the storage unit being configured to store a first common key for both the information processing apparatus and a predetermined measuring apparatus and at least a first private key out of a pair of the first private key and a first public key assigned to the measuring apparatus;

an acquiring unit configured to acquire, from the measuring apparatus, communication data including measurement data measured by the measuring apparatus and an authentication code generated for the measurement data using the first common key;

an authentication unit configured to authenticate, in the secure area, the authentication code in the communication data using the first common key;

a signature generation unit configured to generate, in the secure area, when the authentication code is authenticated, a first digital signature for the measurement data in the communication data using the first private key; and

a transmitting unit configured to transmit, to a predetermined node, transaction data including the measurement data and the first digital signature to cause the node to record the transaction data in a blockchain.

(Supplement A2)

The information processing apparatus according to supplement A1, wherein the storage unit is configured to further store at least a second private key out of a pair of the second private key and a second public key assigned to the information processing apparatus,

the signature generation unit is configured to further generate, in the secure area, a second digital signature for the measurement data and the first digital signature using the second private key, and

the transmitting unit is configured to further include the second digital signature in the transaction data and transmit the resultant transaction data to the node.

(Supplement A3)

The information processing apparatus according to supplement A1 or A2, further including:

a key generation unit configured to generate, in the secure area, the pair of the first private key and the first public key, assign the first private key to identification information of the measuring apparatus, store, in the storage unit, the first private key assigned to the identification information, and output a pair of the first public key and the identification information to an area outside the secure area; and

a publishing unit configured to publish the output pair of the first public key and the identification information outside the information processing apparatus.

(Supplement A4)

The information processing apparatus according to any one of supplements A1 to A3, wherein the storage unit is configured to assign a different pair of the first private key and the first common key to a corresponding one of two or more of the measuring apparatuses and store the assigned different pair of the first private key and the first common key,

the authentication unit is configured to authenticate the authentication code using the first common key assigned to a measuring apparatus of the two or more of the measuring apparatuses from which the communication data is acquired, and

the signature generation unit is configured to generate the first digital signature using the first private key assigned to the measuring apparatus from which the communication data is acquired.

(Supplement A5)

The information processing apparatus according to supplement A4, wherein the signature generation unit is configured to, when first communication data is acquired from a first measuring apparatus and second communication data is acquired from a second measuring apparatus within a predetermined time and when the authentication unit authenticates a first authentication code in the first communication data and a second authentication code in the second communication data, generate, in the secure area, the first digital signature for first measurement data in the first communication data and second measurement data in the second communication data using the first private key, and

the transmitting unit is configured to transmit the transaction data including the first measurement data, the second measurement data, and the first digital signature to the node.

(Supplement A6)

The information processing apparatus according to any one of supplements A1 to A5, further including a key update unit configured to generate, in the secure area, a second common key each time the number of times the communication data is acquired from the measuring apparatus reaches a predetermined number of times, transmit the second common key to the measuring apparatus to cause the measuring apparatus to update the first common key, and update, in the storage unit, the first common key to the second common key.

(Supplement A7)

The information processing apparatus according to any one of supplements A1 to A6, further including a transmission control unit configured to cause the transmitting unit to transmit the transaction data each time the number of times the communication data is acquired from the measuring apparatus reaches a predetermined number of times.

(Supplement A8)

The information processing apparatus according to any one of supplements A1 to A7, further including a processing unit configured to perform, each time the number of times the communication data is acquired from the measuring apparatus reaches a predetermined number of times, predetermined processing on a predetermined number of pieces of the measurement data in a predetermined number of pieces of the communication data acquired most recently,

wherein the signature generation unit is configured to generate, in the secure area, the first digital signature for processed data obtained through the processing using the first private key.

(Supplement A9)

The information processing apparatus according to any one of supplements A1 to A8, wherein the communication data includes the authentication code and encrypted data obtained by encrypting, by the measuring apparatus, the measurement data using the first common key,

the information processing apparatus further includes a decryption unit configured to decrypt, in the secure area, when the authentication code is authenticated, the encrypted data in the communication data to the measurement data using the first common key, and

the signature generation unit is configured to generate, in the secure area, the first digital signature for the decrypted measurement data using the first private key, the decrypted measurement data being obtained through the decryption.

(Supplement A10)

The information processing apparatus according to any one of supplements A1 to A8, wherein the secure area is a trusted execution environment (TEE) that is a more secure execution environment than an area outside the secure area in the information processing apparatus.

(Supplement B1)

A measuring apparatus including:

a sensor configured to acquire measurement data through predetermined measurement;

a storage unit configured to store the first common key;

a generation unit configured to generate an authentication code for the measurement data using the first common key;

a transmitting unit configured to transmit communication data including the authentication code and the measurement data to the information processing apparatus according to any one of supplements A1 to A5; and

a key update unit configured to generate a second common key each time the number of times the communication data is transmitted to the information processing apparatus reaches a predetermined number of times, transmit the second common key to the information processing apparatus to cause the information processing apparatus to update the first common key, and update, in the storage unit, the first common key to the second common key.

(Supplement C1)

A node including:

a storage unit configured to store a first public key out of a pair of a first private key and the first public key assigned to a predetermined measuring apparatus;

a receiving unit configured to receive, from an information processing apparatus, transaction data including measurement data measured by the measuring apparatus and a first digital signature, the first digital signature being generated from the measurement data using the first private key in a secure area of the information processing apparatus when communication data is authenticated in the secure area using a first common key, the communication data including the measurement data and an authentication code generated for the measurement data using the first common key;

a verification unit configured to verify the first digital signature included in the transaction data using the first public key; and

a signature generation unit configured to generate, for the transaction data, a node signature being a digital signature for recording the transaction data in a blockchain, when the first digital signature is verified.

(Supplement C2)

The node according to supplement C1, wherein the storage unit is configured to further store a second public key out of a pair of a second private key and the second public key assigned to the information processing apparatus,

the transaction data further includes a second digital signature generated, in the secure area, for the measurement data and the first digital signature using the second private key,

the verification unit is configured to further verify the second digital signature included in the transaction data using the second public key, and

the signature generation unit is configured to generate the node signature when the first and second digital signatures are verified.

(Supplement D1)

A data recording method, including:

by a computer, acquiring, from a predetermined measuring apparatus, communication data including measurement data measured by the measuring apparatus and an authentication code generated for the measurement data using a first common key for both the computer and the measuring apparatus;

authenticating, in a secure area, the authentication code in the communication data using the first common key;

generating, in the secure area, when the authentication code is authenticated, a first digital signature for the measurement data in the communication data using a first private key out of a pair of the first private key and a first public key assigned to the measuring apparatus; and

transmitting transaction data including the measurement data and the first digital signature to a predetermined node to cause the node to record the transaction data in a blockchain.

(Supplement E1)

A non-transitory computer readable medium storing a program causing a computer to execute:

authentication processing of authenticating, in a secure area, an authentication code in communication data using a first common key for both the computer and a predetermined measuring apparatus, the communication data including measurement data measured by the measuring apparatus and the authentication code generated for the measurement data using the first common key;

signature generation processing of generating, in the secure area, when the authentication code is authenticated, a first digital signature for the measurement data in the communication data using a first private key out of a pair of the first private key and a first public key assigned to the measuring apparatus; and

output processing of outputting transaction data including the measurement data and the first digital signature to an area outside the secure area to transmit the transaction data to a predetermined node to cause the node to record the transaction data in a blockchain.

(Supplement F1)

A data recording method, including:

by a computer, receiving, from an information processing apparatus, transaction data including measurement data measured by a predetermined measuring apparatus and a first digital signature, the first digital signature being generated, in a secure area of the information processing apparatus, from the measurement data using a first private key out of a pair of the first private key and a first public key assigned to the measuring apparatus when communication data is authenticated in the secure area using a first common key, the communication data including the measurement data and an authentication code generated for the measurement data using the first common key;

verifying the first digital signature included in the transaction data using the first public key; and

generating, for the transaction data, a node signature being a digital signature for recording the transaction data in a blockchain, when the first digital signature is verified.

(Supplement G1)

A non-transitory computer readable medium storing a program causing a computer to execute:

processing of receiving, from an information processing apparatus, transaction data including measurement data measured by a predetermined measuring apparatus and a first digital signature, the first digital signature being generated, in a secure area of the information processing apparatus, from the measurement data using a first private key out of a pair of the first private key and a first public key assigned to the measuring apparatus when communication data is authenticated in the secure area using a first common key, the communication data including the measurement data and an authentication code generated for the measurement data using the first common key;

processing of verifying the first digital signature included in the transaction data using the first public key; and

processing of generating, for the transaction data, a second digital signature for recording the transaction data in a blockchain, when the first digital signature is verified.

Although the present invention has been described above with reference to the example embodiments (and examples), the present invention is not limited to the above example embodiments (and examples). Various changes that can be understood by those skilled in the art can be made to the configurations and details of the present invention within the scope of the present invention.

### REFERENCE SIGNS LIST

1000 Data recording system
1 Measuring apparatus
2 Information processing apparatus
2a THW
2b THW
2c THW
2d THW
20 Secure area
21 Storage unit
210 Key management table
211 First common key
212 First private key
213 Second private key
220 Key generation unit
221 Authentication unit
221b Authentication unit
222 Signature generation unit
222a Signature generation unit
222b Signature generation unit
222e Signature generation unit
223 Acquiring unit
224 Transmitting unit
224a Transmitting unit
225 Decryption unit
225b Decryption unit
226 Publishing unit
227 Key update unit
228 Transmission control unit
229 Processing unit
23 Secure element
231 Control unit
232 Storage unit
2321 Secure program
233 IF unit
24 Non-secure element
241 Control unit
242 Storage unit
2421 Data delivery program
243 IF unit
244 Communication Unit
3 Node
3a Data management server
3b Data management server
31 Storage unit
310 Key management table
311 First public key
312 Second public key
321 Receiving unit
322 Verification Unit
322a Verification unit
322b Verification Unit
323 Signature generation unit
323a Signature generation unit
324 Recording unit
4 Blockchain
2000 Data recording system
1a IoT device
110 Sensor
120 Storage unit
121 First common key
130 Generation unit
140 Transmitting unit
N Network
3000 Data recording system
11 IoT device
12 IoT device
1n IoT device
4000 Data recording system
1c IoT device
150 Key update unit

What is claimed is:

1. An information processing apparatus comprising:
a secure area and an area outside the secure area;
wherein the secure area includes:
at least one first memory configured to store first instructions and a first common key for both the information processing apparatus and a predetermined measuring apparatus and at least a first private key out of a pair of the first private key and a first public key assigned to the measuring apparatus, and;
at least one first processor; and
wherein the area outside the secure area includes:
at least one second memory configured to store second instructions, and
at least one second processor configured to execute the second instructions to:
acquire, from the measuring apparatus, communication data including measurement data measured by the measuring apparatus and an authentication code generated for the measurement data using the first common key;
wherein the at least one first processor configured to execute the first instructions to:
authenticate, in the secure area, the authentication code in the communication data using the first common key; and
generate, in the secure area, when the authentication code is authenticated, a first digital signature for the measurement data in the communication data using the first private key; and
wherein the at least one second processor further configured to execute the second instructions to:
transmit, to a predetermined node, transaction data including the measurement data and the first digital signature to cause the node to record the transaction data in a blockchain.

2. The information processing apparatus according to claim 1,
wherein the at least one first memory configured to further store at least a second private key out of a pair of the second private key and a second public key assigned to the information processing apparatus, and
wherein the at least one first processor further configured to execute the first instructions to:
generate, in the secure area, a second digital signature for the measurement data and the first digital signature using the second private key, and
wherein the at least one second processor further configured to execute the second instructions to:
include the second digital signature in the transaction data and transmit the resultant transaction data to the node.

3. The information processing apparatus according to claim 1,
wherein the at least one first processor further configured to execute the first instructions to:
generate, in the secure area, the pair of the first private key and the first public key, assign the first private key to identification information of the measuring apparatus, store, in the first memory, the first private key assigned to the identification information, and output a pair of the first public key and the identification information to the area outside the secure area; and
wherein the at least one second processor further configured to execute the second instructions to:
publish the output pair of the first public key and the identification information outside the information processing apparatus.

4. The information processing apparatus according to claim 1,
wherein the at least one first memory configured to assign a different pair of the first private key and the first common key to a corresponding one of two or more of the measuring apparatuses and store the assigned different pair of the first private key and the first common key, and
wherein the at least one first processor further configured to execute the first instructions to:
authenticate the authentication code using the first common key assigned to a measuring apparatus of the two or more of the measuring apparatuses from which the communication data is acquired, and
generate the first digital signature using the first private key assigned to the measuring apparatus from which the communication data is acquired.

5. The information processing apparatus according to claim 4,
wherein the at least one first processor further configured to execute the first instructions to:
when first communication data is acquired from a first measuring apparatus and second communication data is acquired from a second measuring apparatus within a predetermined time and when the authentication unit authenticates a first authentication code in the first communication data and a second authentication code in the second communication data, generate, in the secure area, the first digital signature for first measurement data in the first communication data and second measurement data in the second communication data using the first private key, and
wherein the at least one second processor further configured to execute the second instructions to:
transmit the transaction data including the first measurement data, the second measurement data, and the first digital signature to the node.

6. The information processing apparatus according to claim 1,
wherein the at least one first processor further configured to execute the first instructions to:
generate, in the secure area, a second common key each time the number of times the communication data is acquired from the measuring apparatus reaches a predetermined number of times, transmit the second common key to the measuring apparatus to cause the measuring apparatus to update the first common key, and update, in the first memory, the first common key to the second common key.

7. The information processing apparatus according to claim 1,
wherein the at least one second processor further configured to execute the second instructions to:
transmit the transaction data each time the number of times the communication data is acquired from the measuring apparatus reaches a predetermined number of times.

8. The information processing apparatus according to claim 1,
wherein the at least one second processor further configured to execute the second instructions to:
perform, each time the number of times the communication data is acquired from the measuring apparatus reaches a predetermined number of times, predetermined processing on a predetermined number of pieces of the measurement data in a predetermined number of pieces of the communication data acquired most recently, and
wherein the at least one first processor further configured to execute the first instructions to:
generate, in the secure area, the first digital signature for processed data obtained through the processing using the first private key.

9. The information processing apparatus according to claim 1, wherein
the communication data includes the authentication code and encrypted data obtained by encrypting, by the measuring apparatus, the measurement data using the first common key,
wherein the at least one first processor further configured to execute the first instructions to:
decrypt, in the secure area, when the authentication code is authenticated, the encrypted data in the communication data to the measurement data using the first common key, and
generate, in the secure area, the first digital signature for the decrypted measurement data using the first private key, the decrypted measurement data being obtained through the decryption.

10. The information processing apparatus according to claim 1, wherein
the secure area is a trusted execution environment (TEE) that is a more secure execution environment than an area outside the secure area in the information processing apparatus.

11. A measuring apparatus comprising:
a sensor configured to acquire measurement data through predetermined measurement;
at least one third memory configured to store third instructions and the first common key; and
at least one third processor configured to execute the third instructions to:
generate an authentication code for the measurement data using the first common key;
transmit communication data including the authentication code and the measurement data to the information processing apparatus according to claim 1; and
generate a second common key each time the number of times the communication data is transmitted to the information processing apparatus reaches a predetermined number of times, transmit the second common key to the information processing apparatus to cause the information processing apparatus to update the first common key, and update, in the storage unit, the first common key to the second common key.

12. A node comprising:
at least one fourth memory configured to store fourth instructions and a first public key out of a pair of a first private key and the first public key assigned to a predetermined measuring apparatus;
at least one fourth processor configured to execute the fourth instructions to:
receive, from an information processing apparatus, transaction data including measurement data measured by the measuring apparatus and a first digital signature, the first digital signature being generated from the measurement data using the first private key in a secure area of the information processing apparatus when communication data is authenticated in the secure area using a first common key, the communication data including the measurement data and an authentication code generated for the measurement data using the first common key;
verify the first digital signature included in the transaction data using the first public key; and
generate, for the transaction data, a node signature being a digital signature for recording the transaction data in a blockchain, when the first digital signature is verified.

13. The node according to claim 12, wherein
the at least one fourth memory configured to further store a second public key out of a pair of a second private key and the second public key assigned to the information processing apparatus,
the transaction data further includes a second digital signature generated, in the secure area, for the measurement data and the first digital signature using the second private key, and
wherein the at least one fourth processor further configured to execute the fourth instructions to:
verify the second digital signature included in the transaction data using the second public key, and
generate the node signature when the first and second digital signatures are verified.

14. A data recording method, comprising:
by a computer,
acquiring, from a predetermined measuring apparatus, communication data including measurement data measured by the measuring apparatus and an authentication code generated for the measurement data using a first common key for both the computer and the measuring apparatus;
authenticating, in a secure area, the authentication code in the communication data using the first common key;
generating, in the secure area, when the authentication code is authenticated, a first digital signature for the measurement data in the communication data using a first private key out of a pair of the first private key and a first public key assigned to the measuring apparatus; and
transmitting transaction data including the measurement data and the first digital signature to a predetermined node to cause the node to record the transaction data in a blockchain.

15. (canceled)

16. A data recording method, comprising:
by a computer,
receiving, from an information processing apparatus, transaction data including measurement data measured by a predetermined measuring apparatus and a first digital signature, the first digital signature being generated, in a secure area of the information processing apparatus, from the measurement data using a first private key out of a pair of the first private key and a first public key assigned to the measuring apparatus when communication data is authenticated in the secure area using a first common key, the communication data including the measurement data and an authentication code generated for the measurement data using the first common key;
verifying the first digital signature included in the transaction data using the first public key; and
generating, for the transaction data, a node signature being a digital signature for recording the transaction data in a blockchain, when the first digital signature is verified.

17. (canceled)
